(19) United States
(12) Patent Application Publication
(10) Pub. No.: US 2009/0128301 A1
(43) Pub. Date: May 21, 2009

(54) METHOD OF CONTROLLING DEVICE USING RADIO FREQUENCY IDENTIFICATION AND APPARATUS THEREFOR

(75) Inventors: Hong-seok PARK, Ansan-si (KR); Seong-hua Jeong, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/166,573

(22) Filed: Jul. 2, 2008

(30) Foreign Application Priority Data
Nov. 19, 2007 (KR) 10-2007-118098

(51) Int. Cl. H04Q 5/22

(52) U.S. Cl. 340/10.4

(57) ABSTRACT

A method of controlling a device by using radio frequency identification (RFID). The method includes wirelessly reading out by a first device information relating to data stored in a second device from the second device, determining an operation to be performed by the second device based on the read out information, and wirelessly recording a command corresponding to the determined operation into the second device.

### CROSS-REFERENCE TO RELATED APPLICATIONS

This application claims the benefit and priority under 35 U.S.C. §119(a) of Korean Patent Application No. 10-2007-0118098, filed on Nov. 19, 2007, in the Korean Intellectual Property Office, the disclosure of which is incorporated herein in its entirety by reference.

### BACKGROUND OF THE INVENTION

1. Field of the Invention

The present general inventive concept relates to a method of controlling a device and an apparatus therefore, and more particularly, to a method of controlling a device by using radio frequency identification (RFID) and an apparatus therefore.

2. Description of the Related Art

Currently, portable storage devices such as universal serial bus (USB) memories and memory cards have come into widespread use. The capacities of such portable storage devices are continuously increasing, and according to technology development, the capacities of the portable storage devices are estimated to increase to the point that High Definition (HD) level movie contents will be able to be stored therein.

In addition, such portable storage devices are designed to be small, strong and shock resistant.

However, when data stored in conventional portable storage devices is to be identified or used, the conventional portable storage devices must be installed and connected to an external device and the data stored in the portable storage devices are identified or used through the connected external device.

In order to overcome such a problem, a display unit is installed in the portable storage devices so as to identify data stored in the portable storage devices through the display unit, or a short-distance wireless communication module such as a Bluetooth module is installed in the portable storage devices so as to transmit information related to the data stored in the portable storage devices to an external device from the portable storage devices. However, both methods require their own power sources in the portable storage devices and circuitry becomes complex, causing the size of the portable storage devices to increase.

### SUMMARY OF THE INVENTION

The present general inventive concept provides a method of controlling a device which enables data stored in the device to be identified or accessed without physically connecting to a device which does not have a power source device or a display device installed therein, and an apparatus therefore.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of controlling a second device by a first device by using Radio Frequency Identification (RFID), the method including wirelessly reading out by the first device information relating to data stored in the second device from the second device, determining in the first device an operation to be performed by the second device based on the read out information; and wirelessly recording a command corresponding to the determined operation into the second device by the first device.

The method may further include outputting the information relating to the data stored in the second device, wherein the determining is performed based on the output information

The information relating to the data stored may include at least one of a list of the data and metadata of the data.

The reading and recording are performed by using RFID.

The foregoing and/or other aspects and utilities of the present general inventive concept may also be achieved by providing a method of controlling an operation of a device, the method including searching for whether a command corresponding to an operation to be performed by the device is stored in the device when a power source is applied to the device, and controlling the device to selectively perform the operation corresponding to the command based on a result of the searching, wherein the device includes an electronic tag and the searching is performed so as to determine whether the command is recorded in the electronic tag.

The operation may include at least one of deleting, reproducing, and executing data stored in the device, and receiving data from an external device.

Information relating to data stored in the device may be changed due to the performance of the operation, and the method may further include refreshing the information relating to the data according to the change, wherein the information relating to the data includes at least one from a list of the data and metadata of the data.

The device may be connected to an external device, and the method may further include converting a format of the command into a format readable by the external device.

The foregoing and/or other aspects and utilities of the present general inventive concept may also be achieved by providing an apparatus to control a second device by a first device by using Radio Frequency Identification (RFID), the apparatus including a reading unit to wirelessly read out from the second device information relating to data stored in the second device by the first device, an operation determining unit of the first device to determine an operation to be performed by the second device based on the read out information, and a recording unit to wirelessly record a command corresponding to the determined operation into the second device.

The apparatus may further include an output unit to output the information read out from the second device relating to the data stored in the second device, wherein the operation determining unit determines the operation based on the output information.

The information relating to the stored data may include at least one of a list of the data and metadata of the data.

The foregoing and/or other aspects and utilities of the present general inventive concept may also be achieved by providing an apparatus to control an operation of a device, the apparatus including an electronic tag in which a command corresponding to an operation to be performed by the device is recorded, a searching unit to search for whether the command is recorded in the electronic tag when a power source is applied to the device, and a control unit to control the device to selectively perform the operation corresponding to the command based on the search result.

The operation may include at least one of deleting, reproducing, and executing the data stored in the device, and receiving the data from an external device.

When the device is connected to an external device, the device may further include a converting unit to convert a format of the command into a format readable by the external device.

The foregoing and/or other aspects and utilities of the present general inventive concept may also be achieved by providing computer readable recording medium having embodied thereon a computer program for executing the method of controlling a second device by a first device by using Radio Frequency Identification (RFID), the method including wirelessly reading out by the first device information relating to data stored in the second device from the second device, determining in the first device an operation to be performed by the second device based on the read out information, and wirelessly recording a command corresponding to the determined operation into the second device by the first device.

The foregoing and/or other aspects and utilities of the present general inventive concept may also be achieved by providing computer readable recording medium having embodied thereon a computer program for executing the method of controlling an operation of a device, the method including searching for whether a command corresponding to an operation to be performed by the device is stored in the device when a power source is applied to the device, and controlling the device to selectively perform the operation corresponding to the command based on a result of the searching, wherein the device includes an electronic tag and the searching is performed to determine whether the command is recorded in the electronic tag.

The foregoing and/or other aspects and utilities of the present general inventive concept may also be achieved by providing an apparatus to wirelessly control a second device by a first device including a reading unit of the first device to read out information related to data stored in a Radio Frequency Identification (RFID) tag disposed in the second device, a display of the first device to display the read out information of the second device, and a recording unit of the first device to store in the RFID tag of the second device a command entered in the first device according to the display of the read out information of the second device.

The first device may have a power source and the second device may have no power source or display.

The foregoing and/or other aspects and utilities of the present general inventive concept may also be achieved by providing a method of controlling a second device by a first device, the method including reading by the first device information related to data stored in a Radio Frequency Identification (RFID) tag disposed in the second device, displaying in the first device the read out information of the second device, and storing in the RFID tag of the second device a command entered in the first device according to the displaying of the read out information of the second device.

The second device may include no power source or display.

The foregoing and/or other aspects and utilities of the present general inventive concept may also be achieved by providing an apparatus using Radio Frequency Identification (RFID), the apparatus including a memory device having a memory to store data, a RFID tag to communicate with a wireless device to receive a command from the wireless device and to store the command, and a terminal to connect to a terminal of an external device to communicate with the external device to control the external device according to the stored command.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram of an apparatus to control a device according to an embodiment of the present general inventive concept;

FIG. 2 is a flowchart illustrating a method of controlling a device according to an embodiment of the present general inventive concept;

FIG. 3 is a diagram to illustrate a method of controlling a device according to an embodiment of the present general inventive concept;

FIG. 4 is a block diagram of an apparatus to control operation of a device according to an embodiment of the present general inventive concept;

FIG. 5 is a block diagram to illustrate operation of an apparatus to control operation of a device according to an embodiment of the present general inventive concept;

FIG. 6 is a flowchart illustrating a method of controlling operation of a device according to an embodiment of the present general inventive concept; and

FIG. 7 is a diagram to illustrate a method of controlling operation of a device according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

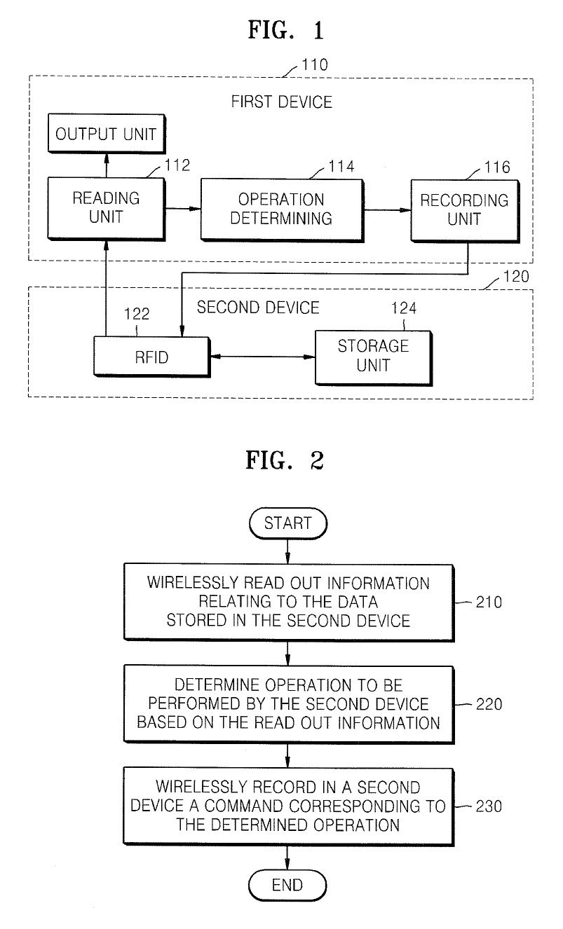

FIG. 1 is a block diagram of an apparatus 100 to control a second device 120 according to an embodiment of the present general inventive concept. The apparatus 100 may be a Radio Frequency Identification (RFID) apparatus to communicate with the second device 120 using RFID.

Referring to FIG. 1, the apparatus 100 to control a second device 120 may be disposed within a first device 110 and may include a reading unit 112, an operation determining unit 114, a recording unit 116, and an output unit 118.

In this embodiment, a second device 120 is a device in which a power source and a display are not included therein. For example, the second device 120 may be, for example, a USB memory device or a memory card having a storage unit 124 to store data.

The first device 110 communicates with the second device 120 by using RFID. Therefore, an electronic tag, which may be, for example, an RFID tag 122, to communicate with the first device 110 may be disposed within the second device 120.

In this embodiment, the first device 110 may be a device such as a computer, a mobile phone, or other electronic device within which an RFID reading unit 112 is disposed.

The reading unit 112 of the first device 110 wirelessly reads out information from the second device 120 relating to data stored in the second device 120.

More specifically, the reading unit 112 reads out information relating to the data stored in the storage unit 124 of the second device 120 from the RFID tag 122 included in the second device 120.

In this embodiment, information relating to the data stored in the second device 120 may include at least one of a list of data and metadata of the data.

The operation determining unit 114 of the first device 110 determines an operation to be performed by the second device 120 based on information read out by the reading unit 112.

In this embodiment, the operation to be performed by the second device 120 may include at least one of deleting, reproducing, and executing data stored in the second device 120, and receiving data from an external device.

The recording unit 116 of the first device 110 wirelessly records a command corresponding to the operation determined by the operation determining unit 114 into the second device 120.

More specifically, the recording unit 116 wirelessly records a command corresponding to the operation determined by the operation determining unit 114 into the RFID tag 122 included in the second device 120.

FIG. 2 is a flowchart illustrating a method of controlling a device according to an embodiment of the present general inventive concept.

In operation 210, information relating to the data stored in the second device is wirelessly read out.

In operation 220, an operation to be performed by the second device is determined based on the read out information.

In operation 230, a command corresponding to the determined operation is wirelessly recorded in the second device.

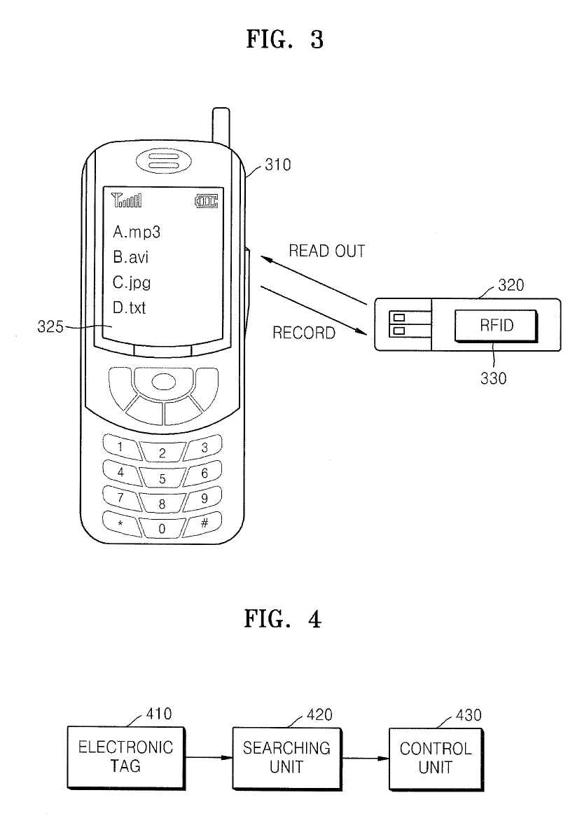

FIG. 3 is a diagram to illustrate a method of controlling a device according to an embodiment of the present general inventive concept.

Referring to FIG. 3, a mobile phone 310 in which the apparatus to control a device according to an embodiment of the present general inventive concept is disposed, and a USB memory 320, are illustrated. In the present general inventive concept, it is assumed that an RFID tag 330 is disposed in the USB memory 320.

In FIG. 3, when the mobile phone 310 approaches to within close proximity to the USB memory 320, the apparatus 100 (referring to FIG. 1) to control a device, and disposed within the mobile phone 310, reads out a list of contents stored in the USB memory 330 from the RFID tag 320 disposed in the USB memory 320 and displays the list of contents on a screen 325 of the mobile phone 310.

When the list of the contents is displayed on the screen 325 of the mobile phone 310, a user may select at least one item from among the contents displayed on the screen 325 and determine the operation to be performed with respect to the selected at least one item. For example, the user may select an operation of deleting the at least one item or reproducing the at least one item.

The apparatus 100 to control a device according to an embodiment of the present general inventive concept may further include an output unit 118 (referring to FIG. 1), to output information relating to the data to the screen 325.

When the determination of the operation to be performed is completed, the mobile phone 310 generates a command corresponding to the determination and records the command in the RFID tag 330 included in the USB memory 320.

According to an embodiment of the present general inventive concept, without displaying the list of contents stored in the USB memory 320 on the screen 325, the mobile phone 310 can automatically determine the operation to be performed by the USB memory 320 based on the list of the contents read out from the USB memory 320 and can automatically generate a predetermined command corresponding to the determination, thereby recording the predetermined command in the RFID tag 330 included in the USB memory 320.

For example, when moving picture file content exists in the USB memory 320, the mobile phone 310 can automatically record a predetermined command to reproduce the moving picture file content in the RFID tag 330 included in the USB memory 320.

In this example, when the predetermined command is recorded in the RFID tag 330 included in the USB memory 320, the USB memory 320 performs the operation corresponding to the command when the USB memory 320 is connected to an external device, such as a computer, with which to perform the reproducing operation.

In another example, when a command is entered at the mobile phone 310 to delete the mp3 file of item A from the list of contents stored in the USB memory 320 which are displayed on screen 325, as illustrated in FIG. 3, and the USB memory 320 is then connected to a computer (not illustrated) and a power source of the computer is applied to the USB memory 320, the USB memory 320 performs the operation and deletes the mp3 file of item A.

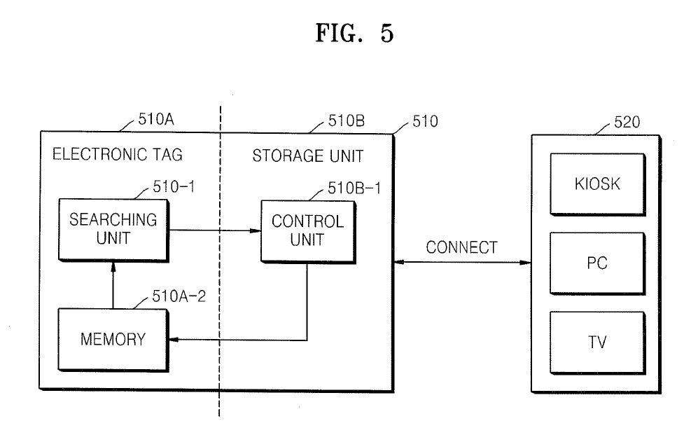

The operation of the USB memory 320 is described in more detail with reference to FIGS. 4 and 5.

FIG. 4 is a block diagram of an RFID apparatus to control operation of a device according to an embodiment of the present general inventive concept.

Referring to FIG. 4, the RFID apparatus to control operation of a device may include an electronic tag 410, which may be, for example, an RFID tag, a searching unit 420, and a control unit 430.

In the electronic tag 410, a command corresponding to the operation to be performed by the device is recorded.

In this embodiment, the device in which the electronic tag 410 is included may be a portable storage device, such as a USB memory device. However, the device is not to be limited to a portable storage device and may include all passive devices which do not have a power source or a display disposed therein or thereon, such that data stored in the device cannot be accessed or identified without connecting the device to an external device.

Accordingly, in the present general inventive concept, the electronic tag 410 is disposed in a portable storage device which does not have a power source or a display disposed therein or thereon, and a command corresponding to an operation to be performed by the device is recorded in the electronic tag 410 through an external device in which an RFID reader and writer is disposed, thereby controlling the portable storage device.

In addition, a list of the data stored in the device may be recorded in the electronic tag 410 included in the portable storage device so that the external device in which an RFID reader is installed can read out information relating to the data stored in the device. Accordingly, information relating to the data stored in the device can be provided to a user without requiring a power source and/or a display to be included with the device.

When a power source is applied to the device, the searching unit 420 searches for whether a command is recorded in the electronic tag 410.

The control unit 430 controls the device to selectively perform an operation corresponding to a command located by the searching unit 420.

The operation corresponding to the located command may be one of deleting, reproducing, and executing the data, and receiving the data from an external device.

For example, the control unit 430 can control the device so as to download movie contents from the external device or to delete contents stored in the device.

The searching unit 420 and the control unit 430 can be separate units from the electronic tag 410 and disposed in the device. They can also be included in the electronic tag 410.

For example, when the RFID apparatus to control operation of a device according to an embodiment of the present general inventive concept is disposed in a USB memory, the searching unit 420 and the control unit 430 can be disposed in a storage space of the USB memory. In another embodiment, the searching unit 420 and the control unit 430 can be disposed in the electronic tag 410 included in the USB memory. In this embodiment, the searching unit 420 and the control unit 430 are generally disposed in the electronic tag 410 as software, but they may also be disposed in the electronic tag 410 as hardware.

FIG. 5 is a block diagram to illustrate operation of an RFID apparatus to control operation of a device according to another embodiment of the present general inventive concept.

In FIG. 5, an embodiment of the RFID apparatus to control operation of a device 510 is illustrated. In this embodiment, the RFID apparatus to control operation of a device 510 includes an electronic tag 510A and a storage unit 510B. Also, the electronic tag 510A includes a searching unit 510A-1 and a memory 510A-2, and the storage unit 510B includes a control unit 510B-1.

In the memory 510A-2 included in the electronic tag 510A, a command corresponding to an operation to be performed by the device 510 in which the RFID apparatus to control operation of a device 510 is disposed is recorded.

When the device 510 is connected to an external device 520, such as a kiosk, a PC, or a TV, and thus a power source is applied to the device 510, the searching unit 510A-1 searches for whether a command is recorded in the memory 510A-2. When a command is recorded in the memory 510A-2, the recorded command is found by the searching unit 510A-1 and is transmitted to the control unit 510B-1 included in the storage unit 510B.

The control unit 510B-1 controls the device 510 to selectively perform an operation corresponding to the command received from the searching unit 510A-1.

For example, when a command to delete an avi file “A” stored in the storage unit 510B is received from the searching unit 510A-1, the control unit 510B-1 directly deletes the avi file “A” stored in the storage unit 510B or controls the external device 520 to delete the avi file “A” stored in the storage unit 510B.

In this example, when information relating to the data stored in the device is changed according to the operation corresponding to the command, the control unit 510B-1 can record the changed information in the memory 510A-2.

For example, when the avi file “A” and an avi file “B” exist in the storage unit 510B and the avi file “A” is deleted as a result of the operation according to the command, the control unit 510B-1 can record in the memory 510A-2 of the electronic tag 510A the fact that now only the avi file “B” exists in the storage unit 510B.

The reason that the changed information is recorded in the memory 510A-2 is because although information relating to the data stored in the device 510 is changed, if the changed information relating to the data stored in the device 510 is not recorded in the memory 510A-2, incorrect information of the status of the avi files “A” and “B”, which was recorded in the memory 510A-2 prior to change, may otherwise be provided to a user, when the user moves the device 510 to within close proximity of an external device in which an RFID reader to read the device 510 is disposed.

Information relating to the stored data includes at least one of a list of data and metadata of the data.

The RFID apparatus to control operation of a device 510 can be disposed in the control unit 510B-1 and can record the changed information into the memory 510A-2. However, the RFID apparatus may further include a separate unit responsible for such an operation.

In another embodiment, when information relating to the data stored in the device is changed, the RFID apparatus to control operation of a device 510 may further include a refresh unit (not illustrated) to refresh information relating to the data according to the change.

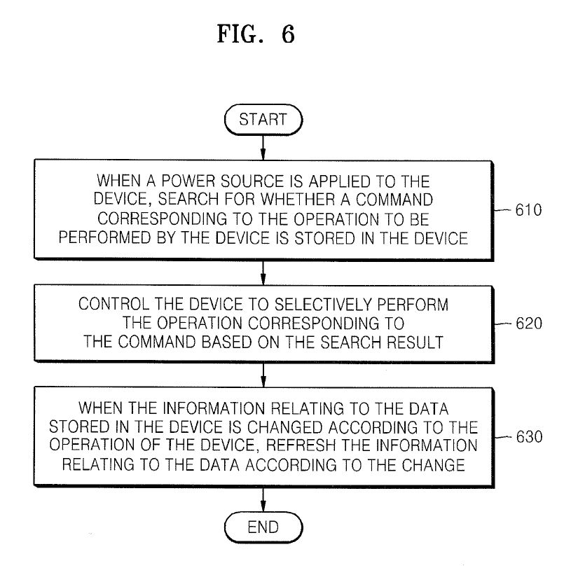

FIG. 6 is a flowchart illustrating a method of controlling operation of a device according to an embodiment of the present general inventive concept.

In operation 610, when a power source is applied to the device, whether a command corresponding to the operation to be performed by the device is stored in the device is determined.

Since the command may be recorded in an electronic tag included in the device, whether the command is stored in the electronic tag is determined.

In operation 620, the device is controlled to selectively perform the operation corresponding to the command based on the result of searching for the command.

In operation 630, when the information relating to the data stored in the device is changed according to the operation of the device, the information relating to the data is refreshed according to the change.

For example, when the avi file “A” and the avi file “B” are stored in the device and the avi file “A” is deleted as a result of the operation according to the command, the fact that only the avi file “B” is now stored in the device is recorded in the electronic tag so as to refresh the information related to the data.

However, when the information relating to the data stored in the device is not changed, operation 630 can be omitted.

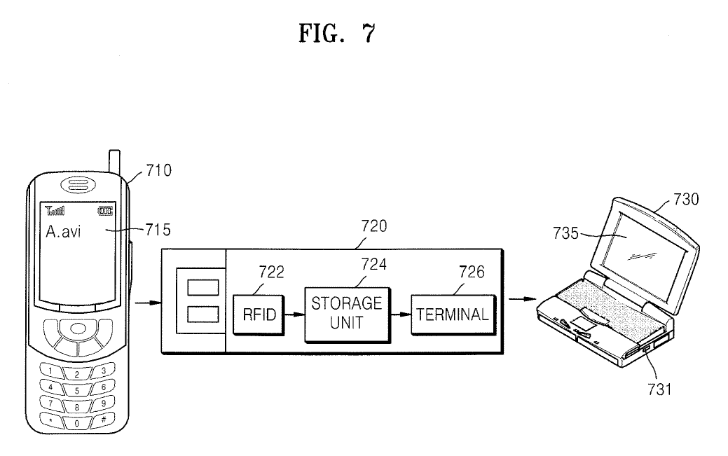

FIG. 7 is a diagram to illustrate a method of controlling operation of a device according to an embodiment of the present general inventive concept.

In FIG. 7, a user of a mobile phone 710 approaches the proximity of a USB memory 720 such that information related to an avi file of an item “A” displayed on a screen 715 of the mobile phone 710 and stored in the USB memory 720 can be read out from an electronic tag, which may be an RFID tag 722 included in the USB memory 720. The USB memory 720 includes a storage unit 724 to store data.

The user can read out the information related to the data stored in the storage unit 724 from the RFID tag 722 by not only using the mobile phone 710 but also all devices which can read out the information recorded in the RFID tag 722.

Accordingly, when the user selects a command to reproduce the avi file of item “A” by using the mobile phone 710 of FIG. 7, a corresponding command is recorded in the RFID tag 722 included in the USB memory 720.

Even though the command is recorded in the USB memory 720, the USB memory itself does not include a power source, so no operation is immediately performed.

However, when a terminal 726 of the USB memory 720 is connected to a corresponding terminal 731 of a laptop computer 730, a power source of the laptop 730 is applied to the USB memory 720 and the RFID apparatus to control operation of a device which is disposed in the USB memory 720 performs the operation corresponding to the command recorded in the RFID tag 722.

Thus, the USB memory 720 includes the terminal 726 to be connected to a corresponding terminal 731 of the laptop 730 to communicate with each other.

For example, the RFID apparatus to control operation of a device performs an operation to reproduce an A.avi file stored in the USB memory 720 on a screen 735 of a laptop computer 730.

In this example, the command stored in the USB memory 720 can be formatted so as not to be read out by the external device. In this case, a process of converting the format of the command stored in the USB memory 720 into a format readable by the external device may be further performed.

The RFID apparatus to control operation of a device may further include a converting unit (not illustrated) to convert the format of the command into a format readable by the external device.

According to the present general inventive concept, when the USB memory 720 with the RFID tag 722 may be connected to the laptop computer 730, the mobile phone 710 can communicate with the USB memory 720 to perform the above-described method, and the USB memory 720 can also communicate with the laptop computer 730 to perform the above-described method.

As described above, in accordance with the present general inventive concept, a user can command the USB memory in which the RFID apparatus to control operation of a device according to the present embodiment is installed to delete an avi file “A” from among the contents stored in the USB memory and to download an avi file “B” by using the mobile phone in which an RFID reader (not illustrated) is installed, while moving. Such a command is recorded in the electronic tag included in the USB memory, and when the user finds the kiosk and the USB memory is inserted into the kiosk, the A.avi file is deleted according to the command recorded in the RFID tag included in the USB memory and the avi file “B” can be downloaded to the USB memory from an external device, for example, a kiosk.

In another application in accordance with the present general inventive concept, while watching a movie by connecting the USB memory, in which the RFID apparatus to control operation of a device is installed, to a display device while riding underground in a subway, if the movie is paused during the trip on the subway, when the user is back home, the user can begin to watch movie after the point where the movie was paused by connecting the USB memory to a laptop computer, due to the refresh of the information related to the data stored in the USB memory.

According to the present general inventive concept, information relating to data stored in a second device is wirelessly read out and an operation to be performed by the second device is determined based on the read out information. Then, a command corresponding to the determined operation is wirelessly recorded in the second device so that the first device can identify the data stored in the second device and allows the data to be accessed without physically connecting to the second device which does not have a power source or display disposed therein.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A method of controlling a second device by a first device by using Radio Frequency Identification (RFID), the method comprising:
wirelessly reading out by the first device information relating to data stored in the second device from the second device;
determining in the first device an operation to be performed by the second device based on the read out information; and
wirelessly recording a command corresponding to the determined operation into the second device by the first device.

2. The method of claim 1, further comprising:
outputting the information relating to the data stored in the second device, wherein the determining is performed based on the output information.

3. The method of claim 1, wherein the information relating to the data stored comprises at least one of a list of the data and metadata of the data.

4. A method of controlling an operation of a device, the method comprising:
searching for whether a command corresponding to an operation to be performed by the device is stored in the device when a power source is applied to the device; and
controlling the device to selectively perform the operation corresponding to the command based on a result of the searching,
wherein the device comprises an electronic tag and the searching is performed to determine whether the command is recorded in the electronic tag.

5. The method of claim 4, wherein the operation comprises at least one of deleting, reproducing, and executing data stored in the device, and receiving data from an external device.

6. The method of claim 4, wherein information relating to data stored in the device is changed due to the performance of the operation, and the method further comprises:
refreshing the information relating to the data according to the change, wherein the information relating to the data comprises at least one from a list of the data and metadata of the data.

7. The method of claim 4, wherein the device is connected to an external device, and the method further comprises:
converting a format of the command into a format readable by the external device.

8. An apparatus to control a second device by a first device by using Radio Frequency Identification (RFID), the apparatus comprising:
a reading unit of the first device to wirelessly read out from the second device information relating to data stored in the second device by the first device;
an operation determining unit of the first device to determine an operation to be performed by the second device based on the read out information; and
a recording unit to wirelessly record a command corresponding to the determined operation into the second device.

9. The apparatus of claim 8, further comprising:
an output unit to output the information read out from the second device relating to the data stored in the second device, wherein the operation determining unit determines the operation based on the output information.

10. The apparatus of claim 8, wherein the information relating to the stored data comprises at least one of a list of the data and metadata of the data.

11. An apparatus to control an operation of a device, the apparatus comprising:
an electronic tag in which a command corresponding to an operation to be performed by the device is recorded;
a searching unit to search for whether the command is recorded in the electronic tag when a power source is applied to the device; and
a control unit to control the device to selectively perform the operation corresponding to the command based on the search result.

12. The apparatus of claim 11, wherein the operation comprises at least one of deleting, reproducing, and executing data stored in the device, and receiving data from an external device.

13. The apparatus of claim 11, when information relating to data stored in the device is changed, and further comprising:
a refresh unit to refresh the information relating to the data according to the change,
wherein the information relating to the data comprises at least one from a list of the data and metadata of the data.

14. The apparatus of claim 11, wherein the device is connected to an external device, and further comprising:
a converting unit to convert a format of the command into a format readable by the external device.

15. A computer readable recording medium having embodied thereon a computer program for executing the method of controlling a second device by a first device by using Radio Frequency Identification (RFID), the method comprising:
wirelessly reading out by the first device information relating to data stored in the second device from the second device;
determining in the first device an operation to be performed by the second device based on the read out information; and
wirelessly recording a command corresponding to the determined operation into the second device by the first device.

16. A computer readable recording medium having embodied thereon a computer program for executing the method of controlling an operation of a device, the method comprising:
searching for whether a command corresponding to an operation to be performed by the device is stored in the device when a power source is applied to the device; and
controlling the device to selectively perform the operation corresponding to the command based on a result of the searching,
wherein the device comprises an electronic tag and the searching is performed to determine whether the command is recorded in the electronic tag.

17. An apparatus to wirelessly control a second device by a first device, comprising:
a reading unit of the first device to read out information related to data stored in a Radio Frequency Identification (RFID) tag disposed in the second device;
a display of the first device to display the read out information of the second device; and
a recording unit of the first device to store in the RFID tag of the second device a command entered in the first device according to the display of the read out information of the second device.

18. The apparatus of claim 17, wherein the first device has a power source and the second device has no power source or display.

19. A method of controlling a second device by a first device, the method comprising:
reading by the first device information related to data stored in a Radio Frequency Identification (RFID) tag disposed in the second device;
displaying in the first device the read out information of the second device; and
storing in the RFID tag of the second device a command entered in the first device according to the displaying of the read out information of the second device.

20. The method of claim 19, wherein the second device includes no power source or display.

21. An apparatus using Radio Frequency Identification (RFID), the apparatus comprising:
a memory device having a memory to store data;
a RFID tag to communicate with a wireless device to receive a command from the wireless device and to store the command; and
a terminal to connect to a terminal of an external device to communicate with the external device to control the external device according to the stored command.
